(19) United States
(12) Patent Application Publication
(10) Pub. No.: US 2008/0306255 A1
(43) Pub. Date: Dec. 11, 2008

(54) Method for Selective Separation of Cellulosic Polymer and Apparatus Therefor

(75) Inventors: Akihiko Ouchi, Ibaraki (JP); Wataru Andou, Ibaraki (JP)

Correspondence Address: MORGAN LEWIS & BOCKIUS LLP, 1111 PENNSYLVANIA AVENUE NW, WASHINGTON, DC, 20004, US

(73) Assignee: NATIONAL INSTITUTE OF ADVANCED INDUSTRIAL SCIENCE, Tokyo (JP)

(21) Appl. No.: 11/883,126

(22) PCT Filed: Jan. 25, 2006
(86) PCT No.: PCT/JP2006/301094

§ 371 Date: Jul. 26, 2007

(30) Foreign Application Priority Data
Jan. 31, 2005 (JP) 2005-023248
Jan. 23, 2006 (JP) 2006-013574

(51) Int. Cl. C08B 1/00; B01J 19/00

(52) U.S. Cl. 536/127; 422/131

(57) ABSTRACT

A matter to be treated which contains a cellulosic polymer is heated in a solvent in the presence of an acid catalyst, to thereby selectively decompose the cellulosic polymer to a fine powder. Furthermore, a matter to be treated which contains a cellulosic polymer is reacted with an esterification agent in the presence of an acid catalyst, to thereby selectively dissolve or disperse the cellulosic polymer. In either method, the treated matter other than the cellulosic polymer does not change in state but remains solid, so that both can be easily separated by sieving or solid-liquid separation.

### TECHNICAL FIELD

The present invention relates to a technology for selective separation of a cellulosic polymer from a matter to be treated, such as a processed article containing a cellulosic polymer, and more particularly to a method for selective separation of the cellulosic polymer by heating a processed article containing the cellulosic polymer or the like in a solvent in the presence of an acid catalyst, and an apparatus therefor.

### BACKGROUND ART

Recently, cellulosic polymers have been widely utilized in clothing and paper products. However, the cellulosic polymer is not only utilized singly but often used together with a synthetic polymer and the like in preparing a processed article. For example in clothing, it is widely used as a mixed yarn of cotton and polyester and the like. Although cut wastes and scrap cloths resulting from the sewing process of clothing, and used clothing are generated in huge amounts every year, the lack of a simple separation technology for the cellulosic polymers and synthetic polymers poses a problem in realizing an effective recycling of these processed articles (Non-patent Reference 1).

Currently, these processed articles are mostly cut into small pieces and are then filled into the ground or subjected to a combustion. However, if it becomes possible to utilize them at a higher level through a more effective recycling, a technology for saving resources, saving energy and preventing global warming, which are essential for sustainable development of the society, will be achieved.

Furthermore, the cellulosic polymers involve a problem, not only in the processed articles as described above but also in non-processed articles such as plants containing such polymers, that it is difficult to separate cellulose in a simple manner.

Therefore, there is a strong requirement to separate cellulosic polymers from a matter to be treated which contains such cellulosic polymers.

Non-patent Reference 1: Seni seihin risaikuru kondankai houkokusho (Report by the round-table conference on textile product recycling), Ministry of Economy, Trade and Industry, Manufacturing Industry Bureau, Textile Division

### DISCLOSURE OF THE INVENTION

### Problems that the Invention is to Solve

The present invention has been made to solve such problems, and an object thereof is to provide a method for simlple selective separation of a cellulosic polymer from a matter to be treated which contains a cellulosic polymer by a selective decomposition of the cellulosic polymer, and an apparatus for conducting the method.

### Means for Solving the Problems

As a result of intensive investigations undertaken for solving the drawbacks in the conventional technologies, the present inventors have found that the aforementioned object can be accomplished by a heating with a solvent in the presence of an acid catalyst, and the present invention has thus been made based on the findings.

More specifically, the present application provides following inventions.

(1) A method for selective separation of a cellulosic polymer, comprising heating a matter to be treated which contains a cellulosic polymer in a solvent in the presence of an acid catalyst.

(2) A method for selective separation of a cellulosic polymer, comprising subjecting a matter to be treated which contains a cellulosic polymer and an esterification agent to a reaction under heating in the presence of an acid catalyst.

(3) The method for selective separation of a cellulosic polymer according to (2), wherein the esterification agent is at least one member selected from the group consisting of an organic acid, an organic acid ester and an organic acid anhydride.

(4) The method for selective separation of a cellulosic polymer according to (2) or (3), wherein a solvent is present.

(5) The method for selective separation of a cellulosic polymer according to (1) or (4), wherein the solvent is a protic solvent or a non-protic solvent.

(6) The method for selective separation of a cellulosic polymer according to (5), wherein the protic solvent is an organic acid.

(7) The method for selective separation of a cellulosic polymer according to (6), wherein the organic acid is acetic acid.

(8) The method for selective separation of a cellulosic polymer according to any one of (1) and (4) to (7), wherein the solvent is a mixed solvent.

(9) The method for selective separation of a cellulosic polymer according to any one of (1) to (8), wherein the matter to be treated is a processed article containing a cellulosic polymer.

(10) The method for selective separation of a cellulosic polymer according to (9), wherein the processed article containing a cellulosic polymer is a textile and/or a textile product containing a cellulosic polymer.

(11) The method for selective separation of a cellulosic polymer according to (9), wherein the textile and/or the textile product containing a cellulosic polymer is a mixed fabric and/or a product of mixed fabric of a cellulosic polymer and a polyester.

(12) The method for selective separation of a cellulosic polymer according to (9), wherein the processed article containing a cellulosic polymer is a pulp, a paper and/or a paper product containing a cellulosic polymer.

(13) The method for selective separation of a cellulosic polymer according to any one (1) to (12), which further comprises adding a surfactant.

(14) The method for selective separation of a cellulosic polymer according to any one of (1) to (13), wherein the acid catalyst is a protic acid.

(15) The method for selective separation of a cellulosic polymer according to any one of (1) to (14), wherein the acid catalyst is a Brønsted acid.

(16) The method for selective separation of a cellulosic polymer according to any one of (1) to (15), wherein the acid catalyst is a Lewis acid.

(17) The method for selective separation of a cellulosic polymer according to any one of (1) to (16), wherein the acid catalyst is a mixed catalyst.

(18) The method for selective separation of a cellulosic polymer according to any one of (1) to (17), wherein the acid catalyst is in a form of an aqueous solution or a non-aqueous solution.

(19) A method for selective separation of a cellulosic polymer, comprising adding a solvent and/or an alkaline substance or an alkaline substance dissolved in a solvent, after said heating treatment as described in any one of (1) to (18).

(20) The method for selective separation of a cellulosic polymer according to any one of (1) to (19), wherein a heating temperature is 200° C. or lower.

(21) The method for selective separation of a cellulosic polymer according to any one of (1) to (20), wherein a heating temperature is from 80 to 150° C.

(22) An apparatus for selective separation of a cellulosic polymer, which is for use in conducting the method according to any one of (1) to (21), said apparatus comprising a means for allowing a matter to be treated which contains the cellulosic polymer, and a solvent and/or an esterification agent to a reaction under heating in the presence of an acid catalyst; and a means for selectively recovering a decomposed or dissolved matter of the cellulosic polymer.

(23) The apparatus for selective separation of a cellulosic polymer according to (22), which further comprises a solvent recovery means for purifying and recovering the solvent after the reaction under heating and/or in the course of the reaction.

### Advantage of the Invention

According to the method of the present invention and the apparatus for conducting the method, it is possible to separate and eliminate only a cellulosic polymer from the matter to be treated which contains the cellulosic polymer in a simple process. Accordingly, they enable a highly advanced recycling of the processed article or the like containing the cellulosic polymer, thereby contributing greatly to resources saving, energy saving and prevention of global warming, which are essential for sustainable development of the society.

### BRIEF DESCRIPTION OF THE DRAWINGS

FIG. 1 is an explanatory view illustrating a representative apparatus for selective separation of a cellulosic polymer, which is employed for conducting the method of the present invention.

FIG. 2 is an explanatory view illustrating another representative apparatus, which is employed for conducting the method of the present invention.

FIG. 3 is an explanatory view illustrating still another representative apparatus, which is employed for conducting the method of the present invention.

FIG. 4 is an explanatory view illustrating still another representative apparatus, which is employed for conducting the method of the present invention.

FIG. 5 is an explanatory view illustrating still another representative apparatus, which is employed for conducting the method of the present invention.

### BEST MODE FOR CARRYING OUT THE INVENTION

A matter to be treated which contains a cellulosic polymer, constituting the object matter of the present invention, means any matter to be treated which contains at least a cellulosic polymer as the object matter of selective separation. Examples of such matter to be treated include a non-processed article and a processed article which contain a cellulosic polymer.

Examples of the non-processed article include plants containing a cellulosic polymer. As the processed article, textile products and paper products containing a cellulosic polymer can be considered, but these are not restrictive and any processed article containing a cellulosic polymer may be mentioned. The processed article advantageously employed in the present invention is a mixed fabric and/or a mixed fabric product of a cellulosic polymer and a polyester.

Examples of the cellulosic polymer include a polymer formed by cellulose such as cotton, linen or pulp; a polymer formed by chemically modified cellulose such as cellulose acetates; a polymer formed by replacing a part of hydroxyl groups of cellulose with other functional groups, such as chitin or chitosan; and a polymer formed by substituting a part of the structure of cellulose.

The first method for selective separation of a cellulosic polymer according to the invention is a method in which a matter to be treated which contains a cellulosic polymer is heated in a solvent in the presence of an acid catalyst, and, the second method is a method in which a matter to be treated which contains a cellulosic polymer and an esterification agent are subjected to a reaction under heating in the presence of an acid catalyst.

According to the former method, the cellulosic polymer is selectively decomposed into a fine powder by a reaction of the solvent and the cellulosic polymer or a cleavage of the cellulosic polymer in the treated matter. According to the latter method, the cellulosic polymer is selectively and substantially dissolved or dispersed in the esterification agent or the solvent employed due to a reaction of the cellulosic polymer in the treated matter with the esterification agent and/or the solvent.

In either of the methods, the treated matter other than the cellulosic polymer does not change in the form but remains in a solid state, so that both materials can be easily separated by means of sieving, solid-liquid separation, or the like.

In the followings, the first selective separation method for a cellulosic polymer according to the invention, namely the method of eliminating the cellulosic polymer by the decomposition with heating a matter to be treated which contains the cellulosic polymer in a solvent in the presence of an acid catalyst, will be explained.

The solvent used may be either one of a protic solvent or a non-protic solvent, and such protic solvent and non-protic solvent may be employed singly or may be employed as a mixture of two or more solvents of non-protic solvents, of protic solvents or of non-protic solvents and protic solvents. In addition, in the case of utilizing a mixed solvent of two or more kinds of solvents, it is not necessarily be in a homogeneous solution but the solvents may be in a separated phase.

The non-protic solvent may be any solvent that does not inhibit the reaction, among the conventional non-protic solvents. Examples of such non-protic solvent include polar solvents such as acetonitrile, dimethylsulfoxide, and dimethylformamide, and non-polar solvents, for example, aliphatic hydrocarbons such as decane, dodecane, or tetradecane, and aromatic hydrocarbons (including aromatic hydrocarbon having an aliphatic group within the molecule thereof) such as toluene or xylene may also be used, but these are not restrictive and any non-protic solvent may be employed.

Further, the protic solvent may be any solvent that does not inhibit the reaction, among the conventional protic solvents. Examples of such protic solvent include water, ethanol, n-propanol, isopropanol, n-butanol, sec-butanol, tert-butanol, ethylene glycol, ethylene glycol monoalkyl ether, ethylene glycol monoaryl ether, diethylene glycol, diethylene glycol monoalkyl ether, diethylene glycol monoaryl ether, propylene glycol, propylene glycol monoalkyl ether, propylene glycol monoaryl ether, various diols, monoalkyl ethers of various diols, monoaryl ethers of various diols, glycerin, glycerin derivatives, polyols, propylamine, ethylenediamine, various carboxylic acids, and various polycarboxylic acids, among which water and carboxylic acids are preferable and water and acetic acid are particularly preferable, but these are not restrictive and any protic solvent may be employed.

As the acid catalyst, any of a protic acid, a Brønsted acid, and a Lewis acid may be employed. Such acid catalysts may be employed singly, but may also be employed as a mixed catalyst prepared by combining a plurality thereof Examples of the protic acid and the Brønsted acid include hydrochloric acid, sulfuric acid, phosphoric acid, formic acid, acetic acid and carbonic acid, and examples of the Lewis acid include boron trifluoride, zinc chloride and zinc tetrafluoroborate, but they are not limited to these examples.

Further, such acid catalysts may be dissolved or dispersed in a solvent to be utilized in a form of an aqueous solution or an non-aqueous solution.

Examples of the solvent include a single solvent such as water, an alcohol, a linear or cyclic hydrocarbon and an ether and mixed solvents thereof. The content of the acid catalyst is not particularly limited so long as it is equal to or less than a saturated concentration of the acid catalyst in the solvent, but is advantageously set, preferably from 0.01 wt % to a saturated concentration with respect to the solvent, and more preferably from 0.1 wt % to a saturated concentration.

As a surfactant, any of the conventional surfactants may be employed so long as the decomposition of the cellulosic polymer is not significantly inhibited.

Examples of such surfactants include anionic surfactants such as a higher fatty acid alkaline salt, an alkylsulfuric acid salt, an alkylsulfonic acid salt, an alkylarylsulfonic acid salt, and a sulfosuccinic acid ester salt; cationic surfactants such as a higher aminehalogenic acid salt, an alkylpyridinium halide, and a quaternary ammonium salt; nonionic surfactants such as a polyethylene glycol alkyl ether, a polyethylene glycol fatty acid ester, a sorbitan fatty acid ester, and a fatty acid monoglyceride; and amphoteric surfactants such an amino acid.

Any one of these surfactants may be employed singly, or a mixture of a plurality of surfactants may also be employed. It is also possible to employ a solution of these surfactants. Examples of the solvents include a single solvent such as water, an alcohol, a linear or cyclic hydrocarbon and an ether, and a mixed solvent thereof. The content of the surfactant is not particularly limited so far as it is equal to or less than a saturated concentration of the surfactant in the solvent, but is advantageously set, preferably from 0.0001 to 50 wt % with respect to the solvent, and more preferably from 0.01 to 10 wt %.

The heating temperature in the present invention is not particularly limited, and may be equal to or lower than a boiling point of the solvent to be used and equal to or higher than a solidifying point thereof. However, in the case that the content of the protic solvent is 10% or less, a temperature exceeding the boiling point of the protic solvent may be employed. The heating temperature employed preferably in the invention is from 0 to 200° C. The heating temperature employed particularly preferably in the invention is from 60 to 150° C.

In the followings, the second method for selective separation of a cellulosic polymer according to the invention, namely the method in which a matter to be treated which contains a cellulosic polymer and an esterification agent are subjected to a reaction under heating in the presence of an acid catalyst, thereby dissolving or dispersing and eliminating the cellulosic polymer, will be explained.

The esterification agent is not particularly limited, but is preferably at least one member selected from the group consisting of an organic acid, an organic acid ester and an organic acid anhydride.

Examples of the organic acid include a carboxylic acid, an organic sulfonic acid, an organic phosphoric acid, an amino acid, and derivatives thereof having a functional group not inhibiting the reaction, and a carboxylic acid is preferable and acetic acid is particularly preferable.

Examples of the organic acid ester include a carboxyl acid ester, a carboxylic acid orthoester, an organic sulfonic acid ester, an organic carbonic acid ester, an organic phosphoric acid ester, an organic orthophosphoric acid ester and derivatives thereof having a functional group not inhibiting the reaction. Among the carboxylic acid esters, an acetic acid orthoester is preferable, and among the organic carbonic acid esters, a dialkylcarbonic acid ester is preferable.

Examples of the organic acid anhydride include acetic anhydride, propionic anhydride, butyric anhydride, valeric anhydride, lauric anhydride, palmitic anhydride, stearic anhydride, malonic anhydride, succinic anhydride, glutaric anhydride, adipic anhydride, acrylic anhydride, cinnamic anhydride, phthalic anhydride, acetic benzoic anhydride, amino acid anhydride, and derivatives thereof having a functional group not inhibiting the reaction, and a carboxylic anhydride is preferable and acetic anhydride is particularly preferable. In a case of employing an organic acid anhydride as the esterification agent, the reaction under heating is desirably conducted in the presence of a solvent as described in the above-mentioned first method, in order to prevent a sudden boiling or the like.

In the second method for selective separation of a cellulosic polymer according to the invention, there is used an acid catalyst similar to that explained in the above-mentioned first method.

In conducting the second method, a solvent and a surfactant are preferably made present, as in the first method, and as to the heating temperature, a condition similar to that in the first method is adopted.

Furthermore, in either of the first and second methods, it is preferable, after the heating treatment, to further add a solvent and/or an alkaline substance or an alkaline substance dissolved in a solvent, in order to promote dissolution, dispersion and pulverization of the cellulosic polymer.

The alkaline substance is not particularly limited, and examples thereof include inorganic compounds such as sodium hydroxide, sodium carbonate, and ammonia; and organic compounds such as dimethylamine, diethylamine, trimethylamine and triethylamine. The addition amount of the alkaline substance is not particularly limited, and the addition amount equal to or larger than an amount required for neutralizing the acid catalyst employed is particularly effective.

In order to conduct the method of the present invention, a matter to be treated which contains a cellulosic polymer and a solvent or an esterification agent may be subjected to a reaction under heating in the presence of the acid catalyst.

Under such specified conditions, as described above, the cellulosic polymer is selectively decomposed (pulverized) by heating in the solvent, or the cellulosic polymer is selectively dissolved or dispersed or pulverized in the presence of the esterification agent, but the treated matter other than the cellulosic polymer does not change in the form thereof and remains in solid state, so that the both can be easily separated by means of sieving or solid-liquid separation.

In the present invention, specific embodiments are not particularly limited, but preferred embodiments include a method in which a matter to be treated which contains a cellulosic polymer is dispersed in a solvent containing an acid catalyst, followed by conducting agitation under heating; and a method in which a matter to be treated which contains a cellulosic polymer and is impregnated with an acid catalyst and an esterification agent is optionally heated in a solvent.

Furthermore, when the processed article containing the cellulosic polymer has a sheet-like form, there can be adopted a method of moving the sheet, under heating, in a solvent or an esterification agent containing the acid catalyst.

However, the specific embodiments of the present invention are not limited thereto.

In the followings, several representative examples of apparatus for selective separation of a cellulosic polymer to be used for conducting the method of the present invention will be shown, but the apparatus of the present invention is not limited thereto.

An apparatus illustrated in FIG. 1 includes a means for heating a solvent and a matter to be treated which contains a cellulosic polymer in the presence of an acid catalyst, and a means for separating and recovering a decomposed product of the cellulosic polymer. This apparatus allows to selectively separate the cellulosic polymer by a method of dispersing and/or dissolving the matter to be treated which contains the cellulosic polymer in a solvent containing an acid catalyst, followed by conducting agitation under heating.

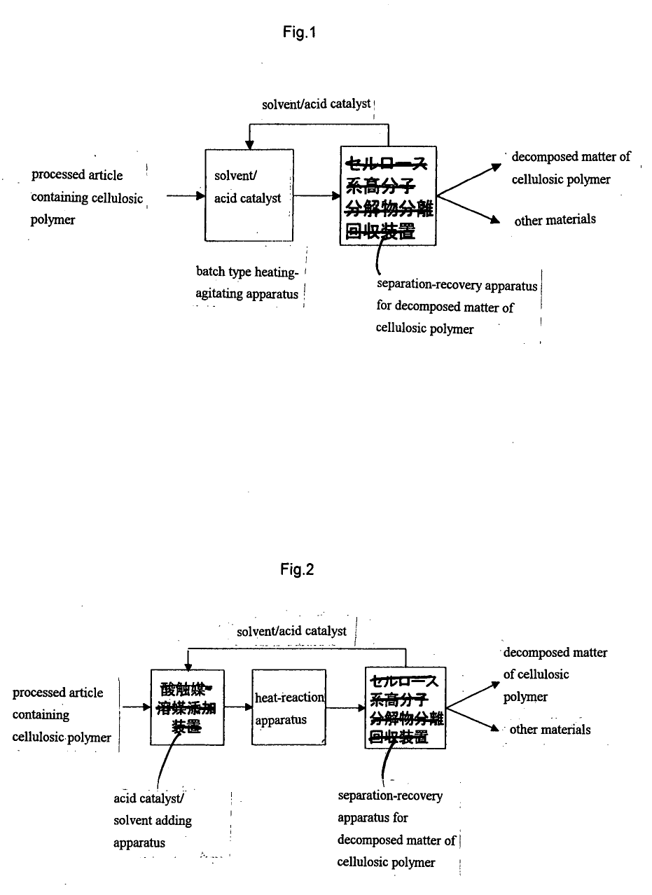

An apparatus illustrated in FIG. 2 includes, in the apparatus shown in FIG. 1, a means which in advance impregnates the matter to be treated which contains the cellulosic polymer with an acid catalyst and a solvent, in addition to the heating means and the means for separating and recovering a decomposed product of the cellulosic polymer. This apparatus is expected to provide a function of continuous processing of a sheet-like matter to be treated.

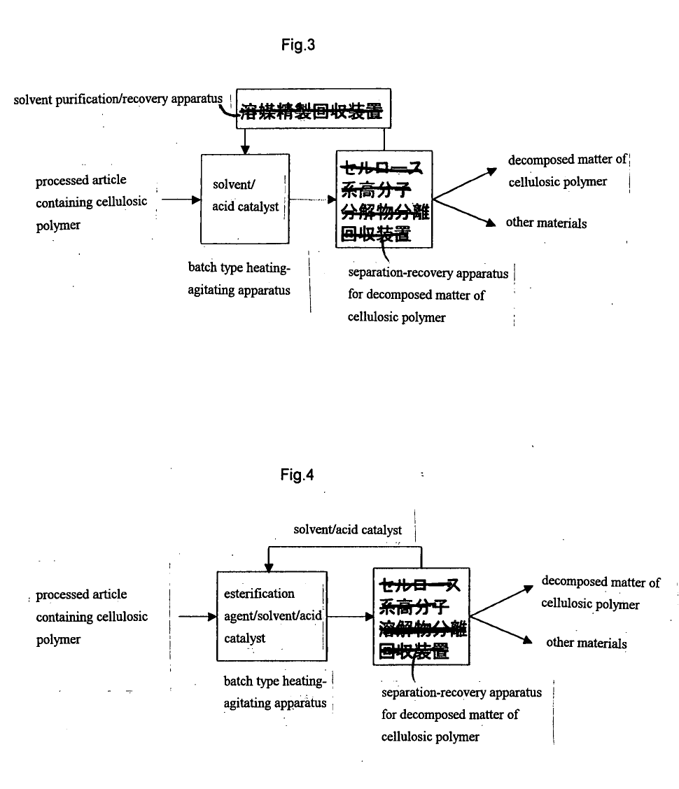

An apparatus illustrated in FIG. 3 includes, in addition to the apparatus shown in FIG. 1, solvent recovery means for recovering the solvent after the heating treatment and/or during the reaction. This apparatus is expected to provide a function of enabling processing of the treated matter of a large amount with the solvent of a limited quantity.

An apparatus illustrated in FIG. 4 includes a means for conducting a reaction under heating of a matter to be treated which contains the cellulosic polymer in the presence of an esterification agent, a solvent and an acid catalyst; and a means for separating and recovering a dissolved product of the cellulosic polymer. This apparatus allows to separate and eliminate the cellulosic polymer by a method of dispersing the matter to be treated which contains the cellulosic polymer in a solvent or the like containing an esterification agent, followed by conducting agitation under heating.

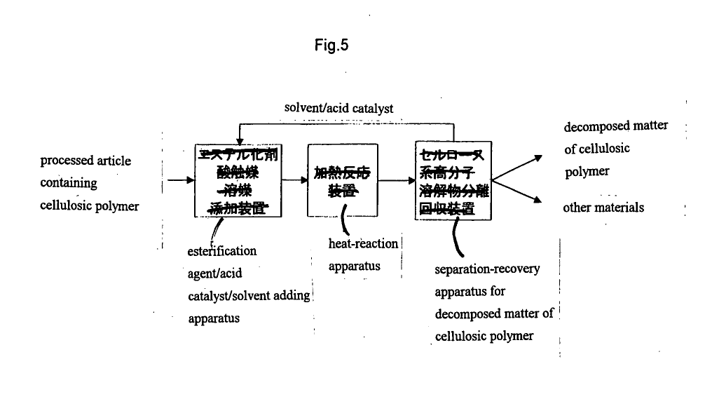

An apparatus illustrated in FIG. 5 includes, in the apparatus shown in FIG. 4, a means which in advance impregnates the matter to be treated which contains the cellulosic polymer with an esterification agent, an acid catalyst and a solvent, in addition to the heating means and the means for separating and recovering a decomposed product of the cellulosic polymer. This apparatus is expected to provide a function of continuous processing of a sheet-like matter to be treated.

### EXAMPLES

Hereinafter, the present invention will be explained in more detail with reference to examples.

### Example 1

A textile containing cotton and polyester in respective amounts of 1.5 g and 1.0 g was dispersed in 30 mL of decane which contains 0.2 g of ZnBF₄ and 0.2 g of tetrabutyl ammonium chloride, and then heated to 120° C. As a result, the cotton in the textile was rapidly decomposed, and there were obtained polyester fabric and a white-colored suspension, and the polyester fabric alone could be separated by a treatment with a saturated aqueous solution of sodium carbonate.

### Example 2

A textile containing cotton and polyester in respective amounts of 1.5 g and 1.0 15 g was dispersed in 30 mL of toluene which contains 0.2 g of ZnBF₄ and 0.2 g of tetrabutyl ammonium chloride, and then heated to 115° C. As a result, the cotton in the textile was rapidly decomposed, and there were obtained polyester fabric and a white-colored suspension, and the polyester fabric alone could be separated by a treatment with a saturated aqueous solution of sodium carbonate.

### Example 3

0.69 g of a knitted textile containing cotton and polyester in a ratio of 1:1 were immersed in concentrated hydrochloric acid, then put and agitated in 80 mL of toluene at 95° C. and rinsed with water. As a result, the textile could be separated into a polyester fabric and white powder.

### Example 4

0.67 g of a textile containing cotton and polyester in a ratio of 35:65 were immersed in concentrated hydrochloric acid, then put and agitated in 80 mL of toluene at 95° C. and rinsed with water. As a result, the textile could be separated into a polyester fabric and white powder.

### Example 5

0.60 g of a textile containing cotton and polyester in a ratio of 35:65 were immersed in 10N sulfuric acid, then put and agitated in 80 mL of toluene at 95° C. and rinsed with water. As a result, the textile could be separated into a polyester fabric and white powder.

### Example 6

1.6 g of a cotton-polyester (1:1) mixed fabric were dispersed in 50 mL of acetic acid which contains 10 mL of acetic anhydride and 1 mL of concentrated sulfuric acid, and then heated to 110° C. As a result, the cotton in the fabric was rapidly decomposed, and there were obtained polyester fabric and a colorless solution, and the polyester fabric could be separated by rinsing the remaining polyester fabric with acetone.

### Example 7

1.6 g of a cotton-polyester (1:1) mixed fabric were dispersed in 50 mL of acetic acid which contains 1 mL of concentrated sulfuric acid, and then heated to 110° C. As a result, the cotton in the fabric was rapidly decomposed, and there were obtained polyester fabric and a colorless solution, and the polyester fabric could be separated by rinsing the remaining polyester fabric with acetone.

1. A method for selective separation of a cellulosic polymer, comprising heating a matter to be treated which contains a cellulosic polymer in a solvent in the presence of an acid catalyst.

2. A method for selective separation of a cellulosic polymer, comprising subjecting a matter to be treated which contains a cellulosic polymer and an esterification agent to a reaction under heating in the presence of an acid catalyst.

3. The method for selective separation of a cellulosic polymer according to claim 2, wherein the esterification agent is at least one member selected from the group consisting of an organic acid, an organic acid ester and an organic acid anhydride.

4. The method for selective separation of a cellulosic polymer according to claim 2, wherein a solvent is present.

5. The method for selective separation of a cellulosic polymer according to claim 1 or 4, wherein the solvent is a protic solvent or a non-protic solvent.

6. The method for selective separation of a cellulosic polymer according to claim 5, wherein the protic solvent is an organic acid.

7. The method for selective separation of a cellulosic polymer according to claim 6, wherein the organic acid is acetic acid.

8. The method for selective separation of a cellulosic polymer according to claim 1 or 4, wherein the solvent is a mixed solvent.

9. The method for selective separation of a cellulosic polymer according to claim 1 or 2, wherein the matter to be treated is a processed article containing a cellulosic polymer.

10. The method for selective separation of a cellulosic polymer according to claim 9, wherein the processed article containing a cellulosic polymer is a textile and/or a textile product containing a cellulosic polymer.

11. The method for selective separation of a cellulosic polymer according to claim 9, wherein the textile and/or the textile product containing a cellulosic polymer is a mixed fabric and/or a product of mixed fabric of a cellulosic polymer and a polyester.

12. The method for selective separation of a cellulosic polymer according to claim 9, wherein the processed article containing a cellulosic polymer is a pulp, a paper and/or a paper product containing a cellulosic polymer.

13. The method for selective separation of a cellulosic polymer according to claim 1 or 2, which further comprises adding a surfactant.

14. The method for selective separation of a cellulosic polymer according to claim 1 or 2, wherein the acid catalyst is a protic acid.

15. The method for selective separation of a cellulosic polymer according to claim 1 or 2, wherein the acid catalyst is a Brønsted acid.

16. The method for selective separation of a cellulosic polymer according to claim 1 or 2, wherein the acid catalyst is a Lewis acid.

17. The method for selective separation of a cellulosic polymer according to claim 1 or 2, wherein the acid catalyst is a mixed catalyst.

18. The method for selective separation of a cellulosic polymer according to claim 1 or 2, wherein the acid catalyst is in a form of an aqueous solution or a non-aqueous solution.

19. A method for selective separation of a cellulosic polymer, comprising adding a solvent and/or an alkaline substance or an alkaline substance dissolved in a solvent, after said heating treatment as described in claim 1 or 2.

20. The method for selective separation of a cellulosic polymer according to claim 1 or 2, wherein a heating temperature is 200° C. or lower.

21. The method for selective separation of a cellulosic polymer according to claim 1 or 2, wherein a heating temperature is from 80 to 150° C.

22. An apparatus for selective separation of a cellulosic polymer, which is for use in conducting the method according to claim 1 or 2, said apparatus comprising a means for allowing a matter to be treated which contains the cellulosic polymer, and a solvent and/or an esterification agent to a reaction under heating in the presence of an acid catalyst; and a means for selectively recovering a decomposed or dissolved matter of the cellulosic polymer.

23. The apparatus for selective separation of a cellulosic polymer according to claim 22, which further comprises a solvent recovery means for purifying and recovering the solvent after the reaction under heating and/or in the course of the reaction.
